(19) United States
(12) Patent Application Publication
(10) Pub. No.: US 2024/0261902 A1
(43) Pub. Date: Aug. 8, 2024

(54) MANUFACTURING METHOD OF METAL MEMBER

(71) Applicant: FUTABA INDUSTRIAL CO., LTD., Okazaki-shi (JP)

(72) Inventors: Yuta Fujikasa, Okazaki-shi (JP); Koji Yamaguchi, Okazaki-shi (JP)

(21) Appl. No.: 18/429,965

(22) Filed: Feb. 1, 2024

(30) Foreign Application Priority Data
Feb. 2, 2023 (JP) 2023-014630

(51) Int. Cl. B23K 26/352

(52) U.S. Cl. CPC B23K 26/355

(57) ABSTRACT

In a manufacturing method of a metal member, two or more laser beams are simultaneously radiated from a single laser apparatus to two or more radiation regions spaced apart from each other on an outer surface of a metal member to thereby form a dimple in each radiation region.

### CROSS-REFERENCE TO RELATED APPLICATIONS

The present application claims the benefit of Japanese Patent Application No. 2023-014630 filed on Feb. 2, 2023 with the Japan Patent Office, the entire disclosure of which is incorporated herein by reference.

### BACKGROUND

The present disclosure relates to a manufacturing method of a metal member.

There has been a known technique to form multiple dimples on an outer surface of a metal member to join a dimpled portion of the outer surface of the metal member and a resin member by an anchoring effect. There has been also a known technique, as disclosed in Japanese Unexamined Patent Application Publication No. 2015-100959, in which multiple dimples are formed on an outer surface of a metal member by laser beam radiation so as to join the metal member and a resin member by the anchoring effect.

### SUMMARY

However, in the technique disclosed in Japanese Unexamined Patent Application Publication No. 2015-100959, one laser beam is radiated in succession to the outer surface of the metal member in order to form multiple dimples. Thus, forming dimples has been time consuming.

In one aspect of the present disclosure, it is desirable to reduce time to form dimples on an outer surface of a metal member.

One aspect of the present disclosure provides a manufacturing method of a metal member. The manufacturing method comprises simultaneously radiating two or more laser beams from a single laser apparatus to two or more radiation regions spaced apart from each other on an outer surface of a metal member to thereby form a dimple in each radiation region of the two or more radiation regions.

According to the aforementioned configuration, two or more laser beams are simultaneously radiated to thereby form two or more dimples on an outer surface of a metal member. This can reduce time to form two or more dimples on the outer surface of the metal member.

In one aspect of the present disclosure, the two or more laser beams may be formed by splitting a laser beam generated by a laser oscillator. Such a configuration enables the two or more laser beams to be simultaneously radiated in a preferred manner.

In one aspect of the present disclosure, during radiation of the two or more laser beams to form the dimple in each radiation region, a high period and a low period may alternately arrive more than once. In the high period, an intensity of each laser beam may be a high-level intensity, and in the low period, the intensity of each laser beam may be reduced to a low-level intensity that is lower than the high-level intensity. The low period may be longer than the high period.

The aforementioned configuration can inhibit a portion between adjacent dimples on the metal member from being melted when the two or more laser beams are radiated, thereby inhibiting the dimples from being deformed.

In one aspect of the present disclosure, the low-level intensity may be zero. This configuration can inhibit deformation of the dimples.

In one aspect of the present disclosure, an evaluation indicator represented by I may be equal to or less than 40.06667. I is calculated by I=P (W)×Thi (ms)/Tlow (ms) where P represents the high-level intensity, Thi represents a duration of the high period, and Tlow represents a duration of the low period. Such a configuration enables the dimples to be formed in a preferred manner.

In one aspect of the present disclosure, I may be equal to or less than 21.46429. Such a configuration enables the dimples to be formed in a more preferred manner.

In one aspect of the present disclosure, each radiation region of the two or more radiation regions may have an approximately circular shape. A distance between adjacent radiation regions of the two or more radiation regions may be greater than a diameter of each radiation region of the adjacent radiation regions.

The aforementioned configuration can inhibit the distance between a first radiation region and a second radiation region from being small. This can inhibit a portion between the first radiation region and the second radiation region from being melted when the two or more laser beams are radiated, thereby inhibiting dimples, which are to be formed in the first radiation region and the second radiation region, being deformed.

### BRIEF DESCRIPTION OF THE DRAWINGS

Example embodiments of the present disclosure will be described hereinafter with reference to the accompanying drawings, in which:

FIG. 1 is an explanatory diagram illustrating a laser apparatus;

FIG. 2 is an explanatory diagram illustrating pulsed radiation of a laser beam;

FIG. 3 is an explanatory diagram illustrating radiation regions of laser beams on an outer surface of a metal member;

FIG. 4 is a cross-sectional view of a metal member with dimples formed therein; and

FIG. 5 is a table showing evaluation results of dimples formed by pulsed radiation in Settings (1) to (6).

### DETAILED DESCRIPTION OF EXEMPLARY EMBODIMENTS

The present disclosure is not limited to below-described embodiments, but may be embodied in various forms within the technical scope of the present disclosure.

### 1. Overview

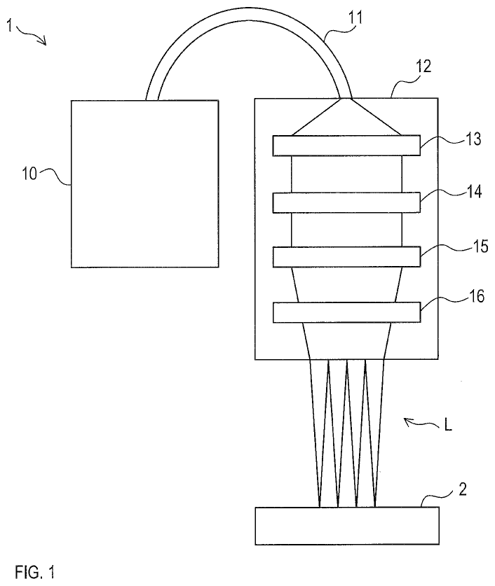

According to a manufacturing method of the present embodiment, a metal member 2 is manufactured in which multiple of hollow-shaped dimples 4 are formed on an outer surface by a laser apparatus 1 (see FIGS. 1, 3, and 4). In one example, the portion of the outer surface of the metal member 2 in which the multiple dimples 4 are formed is joined to a resin member in a manner that a joining strength is improved by an anchoring effect, and thereby a combined member is formed which includes the joined metal member 2 and resin member. The metal member 2 with the multiple dimples 4 formed thereon may be used for other purposes apart from being joined to a resin member.

### 2. Laser Apparatus

The laser apparatus 1 comprises a laser oscillator 10, a light path 11, and a head 12, and is configured to radiate two or more laser beams L from the head 12 to the outer surface of the metal member 2 (see FIG. 1).

The laser oscillator 10 is configured to excite a laser medium and amplify a light emitted by the excited laser medium to thereby generate a laser beam. The laser oscillator 10 may be, for example, configured as a fiber laser in which an optical fiber is used as an amplifying medium.

The light path 11 guides the laser beam generated by the laser oscillator 10 to the head 12.

The head 12 comprises a collimator 13, a diffractive optical element (DOE) 14, a focusing lens 15, and a position corrector 16. The head 12 need not include the position corrector 16.

The collimator 13 adjusts a direction of the laser beam guided from the laser oscillator 10 using, for example, a lens and/or a mirror.

The DOE 14 splits the laser beam that has passed through the light path 11 to produce two or more laser beams L. The two or more laser beams L produced by the DOE 14 are emitted from the head 12.

The focusing lens 15 adjusts a degree of convergence of each of the laser beams L. In welding, the degree of convergence of each laser beam L is adjusted such that each laser beam L converges immediately before the metal member 2.

The position corrector 16 is configured to adjust a target position of each laser beam L, which has passed through the focusing lens 15.

A method for producing the two or more laser beams L is not limited to the one described above, and the two or more laser beams L may be produced by various other methods. Specifically, for example, the two or more laser beams L may be produced by splitting a laser beam into two or more laser beams using a splitter mirror. For another example, the two or more laser beams L may be produced by splitting a laser beam using a planar lightwave circuit (PLC) splitter that splits one optical fiber into two or more optical fibers.

Alternatively, for example, two or more laser beams may be combined by Coherent Beam Combining technology and a profile of the two or more laser beams L to be radiated to the outer surface of the metal member 2 may be formed.

### 3. Manufacturing Method of Metal Member

According to the manufacturing method of the present embodiment, the two or more laser beams L are radiated by the laser apparatus 1 to respective multiple dot-shaped radiation regions 3 on the outer surface of the metal member 2, and thereby a dimple 4 is formed in each of the radiation regions 3 (see FIGS. 1, 3, and 4). The manufacturing method comprises a setting process in which a setting for the two or more laser beams L to be radiated from the laser apparatus 1 is determined, and a radiation process in which the two or more laser beams L are radiated to the metal member 2.

### [3-1. Setting Process]

In the setting process, the laser apparatus 1 is operated by an operator and a profile of the two or more laser beams L to be radiated in the radiation process is set. Specifically, a wavelength, an intensity, and an intensity distribution of the two or more laser beams L, a shape, a size, and a position of the radiation region 3 of each of the two or more laser beams L on the outer surface of the metal member 2, whether to provide pulsed radiation, and an angle of the two or more laser beams L with respect to the outer surface of the metal member 2 may be set, for example.

In one example, each radiation region 3 is set as a dot-shape region. More specifically, each radiation region 3 may be set as an approximately circular-shaped region having a diameter of D1 (see FIG. 3). Without being limited to this shape, each radiation region 3 may be set as an approximately regular polygonal region. In addition, each radiation region 3 may have a different shape.

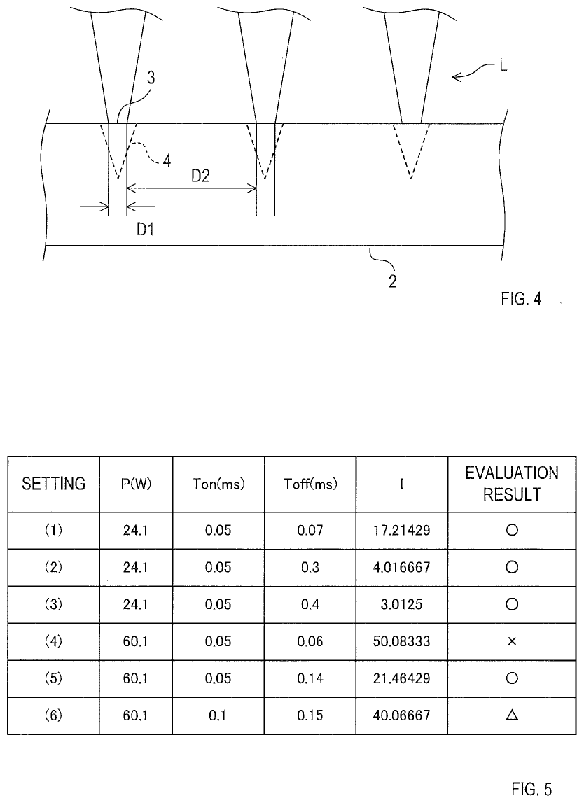

In one example, each radiation region 3 may be set so that the radiation regions 3 are lined up in a rectangular array. In addition, each radiation region 3 may be set so that D2 which is a distance from one radiation region 3 to a closest radiation region 3, in other words the shortest distance that needs to be maintained between two adjacent radiation regions 3, may be set to a value greater than D1, which is the diameter of the radiation region 3 (see FIGS. 3 and 4). Without being limited to such a value, D2 may be set to a value equal to or less than D1. In addition, for some of the radiation regions 3, D2 may be set to be greater than D1.

Also, an arrangement of the radiation regions 3 can be specified as appropriate. For example, the radiation regions 3 may be arranged in one line or may be randomly arranged. Even in such cases, D2 may be set to a value greater than D1, or a value equal to or less than D1.

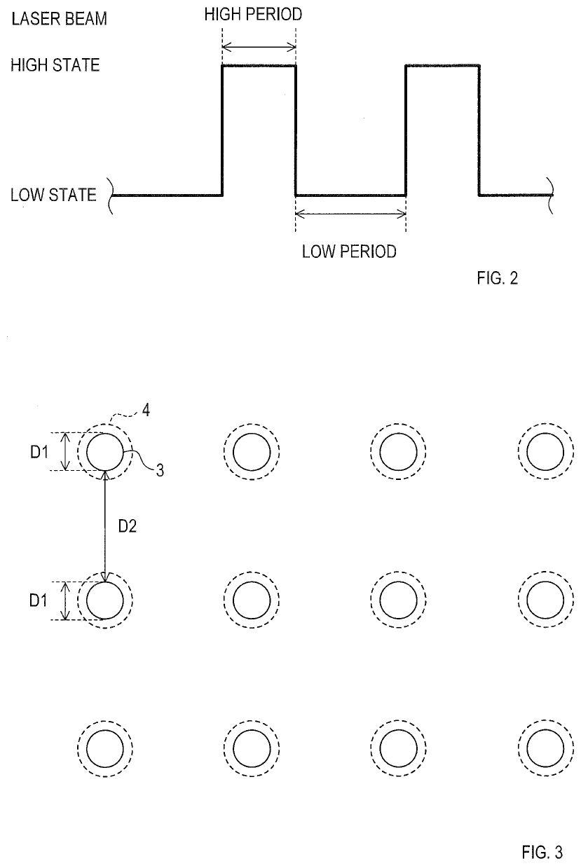

In one example, pulsed radiation may be provided. In a case where pulsed radiation is provided, during radiation of the two or more laser beams L to form the dimples 4, each laser beam L is radiated such that alternation of a high state and a low state is repeated (see FIG. 2). The high state refers to a state in which a laser beam with an intensity specified in advance (hereinafter, “high-level intensity”) is radiated. The low state refers to a state in which the intensity of the laser beam is reduced to an intensity lower than the high-level intensity (hereinafter, “low-level intensity”). For example, in the present embodiment, the intensity of the laser beam becomes zero, and thus no laser beam is radiated in the low state. In addition, in a case where pulsed radiation is provided, a duration of a high period during which the high state continues and a duration of a low period during which the low state continues may be optionally set. Also, the number of times that pulsed radiation is to be provided, in other words, the number of times the state of each laser beam is to be transitioned to the high state in order to form the dimple 4, may be optionally set.

For example, the low period may be set to be longer than the high period. Without being limited to such a duration, the low period may be set to be equal to or shorter than the duration of the high period.

In a case where pulsed radiation is not provided, dimples may be formed by maintaining the high state of each laser beam L during radiation of each laser beam L without changing the high state and the low state in the radiation process.

Further, in one example, the angle of the two or more laser beams L with respect to the outer surface of the metal member 2 is set to be approximately 90°, and the intensity of each laser beam L and an intensity distribution of the laser beam L in each radiation region 3 are set so that approximately cone-shaped dimples 4 are formed (see FIG. 4). However, without being limited to this angle, the angle of the two or more laser beams L with respect to the outer surface of the metal member 2 may be an angle different from approximately 90°. In addition, the shape of each dimple 4 is not limited to an approximately cone shape. The dimple 4 may be formed, for example, to have a quadrangular-shaped or an oval-shaped cross section orthogonal to the outer surface of the metal member 2.

### [3-2. Details of Profile]

Each laser beam L may have a wavelength of 1070 nm, for example. Without being limited to 1070 nm, the wavelength of each laser beam L is set as appropriate.

In addition, the distance D2 between two adjacent radiation regions 3 is set as appropriate.

The diameter D1 of each radiation region 3 having an approximately circular shape is also set as appropriate.

The number of times that pulses are generated while the dimple 4 is formed by pulsed radiation is also set as appropriate.

In pulsed radiation, the intensity (W) of the two or more laser beams L which are radiated to the respective radiation regions 3 in the high state is represented by P, the duration of the high period is represented by Thi (ms), and the duration of the low period is represented by Tlow (ms). In accordance with a formula below, an evaluation indicator I is calculated.

$$I = P \times Thi / Tlow$$

The dimples 4 formed by pulsed radiation in which P, Thi, and Tlow had been set in accordance with Settings (1) to (6) in a table of FIG. 5 were examined. In Setting (4), the dimples 4 were not formed in a preferred manner. In contrast, in Setting (6), the dimples 4 were formed in a preferred manner; and in Settings (1) to (3), and (5), the dimples 4 were formed in a more preferred manner.

Thus, P, Thi, and Tlow may be set such that I becomes equal to or less than 40.06667, in other words I becomes approximately equal to or less than 40. With this setting, the dimples 4 can be formed in a preferred manner. In addition, P, Thi, and Tlow may be set such that I becomes equal to or less than 21.46429, in other words I becomes approximately equal to or less than 21. With this setting, the dimples 4 can be formed in a more preferred manner.

### [3-3. Radiation Process]

The radiation process includes one or more cycles of radiation. In each cycle of radiation, the two or more laser beams L having the profile which has been set in the setting process are simultaneously radiated from the head 12 of the laser apparatus 1 to the outer surface of the metal member 2. Accordingly, the dimple 4 is formed in the radiation region 3 of each laser beam L on the outer surface of the metal member 2 (see FIG. 4).

The dimple 4 on the outer surface of the metal member 2 has an area larger than that of the radiation region 3 in which the dimple 4 is formed (see FIGS. 3 and 4). In other words, each radiation region 3 is located within the region in which the dimple 4 is formed on the outer surface of the metal member 2.

In a case where two or more cycles of radiation is performed, when each cycle of radiation is completed and the dimples 4 are formed on the outer surface of the metal member 2, both of the head 12 and the metal member 2 are, or one of the head 12 or the metal member 2 is moved, and a new region on the outer surface of the metal member 2 is set as a target region. Then, a next cycle of radiation is initiated, and the two or more laser beams L are radiated to the new target region to form the dimples 4 therein. When a required number of cycles of radiation is completed, the radiation process is complete.

In a case where only one cycle of radiation is performed, the radiation process is complete when one cycle of radiation is completed.

### 4. Effects

(1) According to the above-described embodiment, the two or more laser beams L are simultaneously radiated from the head 12 of the laser apparatus 1 to the outer surface of the metal member 2, and thereby the dimples 4 are formed on the outer surface. This can reduce time to form the dimples 4 on the outer surface of the metal member 2.

(2) Since the low period in pulsed radiation is longer than the high period, it is possible to restrict the amount of heat applied to the metal member 2 during pulsed radiation. This can inhibit portions between adjacent dimples 4 on the metal member 2 from being melted due to pulsed radiation and thereby inhibit the dimples 4 from being deformed.

(3) Since the distance D2 between adjacent radiation regions 3 is greater than the diameter D1 of the radiation region 3 having the approximately circular shape, it is possible to inhibit the distance between the adjacent radiation regions 3 from being small. This can inhibit the portions between adjacent radiation regions 3 on the metal member 2 from being melted by radiation of the two or more laser beams L and thereby inhibit the dimples 4 formed in the radiation regions 3 being deformed.

### 5. Other Embodiments

Two or more functions of a single element in the aforementioned embodiments may be achieved by two or more elements, and a single function of a single element may be achieved by two or more elements. Two or more functions performed by two or more elements may be achieved by a single element, and a single function performed by two or more elements may be achieved by a single element. Part of the configuration in the aforementioned embodiments may be omitted. At least a part of a configuration in one of the aforementioned embodiments may be added to or replaced with a configuration in another one of the aforementioned embodiments.

What is claimed is:

1. A manufacturing method of a metal member, the manufacturing method comprising:
simultaneously radiating two or more laser beams from a single laser apparatus to two or more radiation regions spaced apart from each other on an outer surface of a metal member to thereby form a dimple in each radiation region of the two or more radiation regions.

2. The manufacturing method according to claim 1, wherein the two or more laser beams are formed by splitting a laser beam generated by a laser oscillator.

3. The manufacturing method according to claim 1, wherein:
during radiation of the two or more laser beams to form the dimple in each radiation region, a high period and a low period alternately arrive more than once;
in the high period, an intensity of each laser beam of the two or more laser beams is a high-level intensity, and in the low period, the intensity of each laser beam is reduced to a low-level intensity that is lower than the high-level intensity; and
the low period is longer than the high period.

4. The manufacturing method according to claim 3, wherein the low-level intensity is zero.

5. The manufacturing method according to claim 3, wherein:
an evaluation indicator represented by I is equal to or less than 40.06667; and
I is calculated by
$$I = P ( W ) \times Thi ( ms ) / Tlow ( ms )$$
where P represents the high-level intensity, Thi represents a duration of the high period, and Tlow represents a duration of the low period.

6. The manufacturing method according to claim 5, wherein I is equal to or less than 21.46429.

7. The manufacturing method according to claim 1, wherein:
each radiation region of the two or more radiation regions has an approximately circular shape; and
a distance between adjacent radiation regions of the two or more radiation regions is greater than a diameter of each radiation region of the adjacent radiation regions.
